(19) United States
(12) Patent Application Publication
(10) Pub. No.: US 2026/0261975 A1
(43) Pub. Date: Sep. 3, 2026

(54) METHOD FOR SENDING WAKE-UP SIGNAL, METHOD FOR RECEIVING WAKE-UP SIGNAL, AND ELECTRONIC DEVICE

(71) Applicant: Beijing Xiaomi Mobile Software Co., Ltd., Beijing (CN)

(72) Inventor: Ting FU, Beijing (CN)

(73) Assignee: Beijing Xiaomi Mobile Software Co., Ltd., Beijing (CN)

(21) Appl. No.: 19/162,783

(22) PCT Filed: Mar. 8, 2023
(86) PCT No.: PCT/CN2023/080313

§ 371 Date: Sep. 5, 2025

(51) Int. Cl. H04W 52/02; H04W 72/0453; H04W 76/27

(52) U.S. Cl. CPC H04W 52/0235; H04W 72/0453; H04W 76/27

(57) ABSTRACT

An apparatus and methods are provided for low-power wake-up signaling in wireless systems. In one aspect, a network device selectively transmits a first low-power wake-up signal on a first frequency-domain resource to a first user equipment (UE) that is in a radio resource control (RRC) idle or inactive state, and a second low-power wake-up signal on a second, different frequency-domain resource to a second UE that is in an RRC connected state. The resources may be configured to have no overlap. The network device configures the wake-up signals and their resources based on candidate bandwidth parts (BWPs). When candidate first and second BWPs overlap, the device withholds configuration of one wake-up signal and configures the other, selecting its resource from the corresponding BWP, and conditionally sends configuration information to the UE. In another aspect, a UE receives a wake-up signal on a resource determined by its RRC state and interprets configuration signaling according to BWP overlap conditions. Electronic devices with processors and memory implement the network-side and UE-side operations.

### CROSS-REFERENCE TO RELATED APPLICATIONS

The present application is a U.S. National Stage of International Application No. PCT/CN2023/080313 filed on Mar. 8, 2023, the entire contents of which are incorporated herein by reference for all purposes.

### TECHNICAL FIELD

The present disclosure relates to the field of radio communication technology, and in particular, to a method and device for sending or receiving a wake-up signal and a storage medium.

### BACKGROUND

In some radio communication technologies, a low-power (LP) wake-up signal (WUS) may be applied. A user equipment (UE) may be configured with a main transceiver and a low-power wake-up receiver (LP WUR).

A UE uses the main transceiver to process uplink and downlink data and uses the LP WUR to receive a wake-up signal (WUS). For example, when the main transceiver of the UE is in a sleep state, if a separate receiver corresponding to WUS receives WUS, the main transceiver is activated and comes into a working state; and when the main transceiver of the UE is in a sleep state, if the separate receiver corresponding to WUS does not receive WUS or receives WUS but the WUS does not indicates wake-up, the main transceiver would remain in the sleep state.

### SUMMARY

The present disclosure provides a method and device for sending or receiving a wake-up signal and a storage medium.

A first aspect provides a method for sending a wake-up signal performed by a network device, including:
sending a first low-power wake-up signal to a first user equipment on a first frequency-domain resource, and/or sending a second low-power wake-up signal to a second user equipment on a second frequency-domain resource,
wherein the first low-power wake-up signal is configured to wake up the first user equipment, the second low-power wake-up signal is configured to wake up the second user equipment, the first user equipment is in a radio resource control (RRC) idle state or an RRC inactive state, the second user equipment is in an RRC connected state, and the first frequency-domain resource is different from the second frequency-domain resource.

In some possible implementations, the first frequency-domain resource and the second frequency-domain resource have no overlapping region.

In some possible implementations, the method further includes: configuring the first low-power wake-up signal and the second low-power wake-up signal.

In some possible implementations, the method further includes:
not configuring the second low-power wake-up signal when a first bandwidth part and a second bandwidth part have an overlapping region, wherein the first bandwidth part is a candidate bandwidth part for configuring the first low-power wake-up signal, and the second bandwidth part is a candidate bandwidth part for configuring the second low-power wake-up signal.

In some possible implementations, the method further includes: configuring the first low-power wake-up signal.

In some possible implementations, the method further includes: configuring the first low-power wake-up signal including:
configuring the first frequency-domain resource based on the first bandwidth part.

In some possible implementations, the method further includes: sending configuration information of the first low-power wake-up signal to the second user equipment.

In some possible implementations, the method further includes:
not configuring the first low-power wake-up signal when a first bandwidth part and a second bandwidth part have an overlapping region, wherein the first bandwidth part is a candidate bandwidth part for configuring the first low-power wake-up signal, and the second bandwidth part is a candidate bandwidth part for configuring the second low-power wake-up signal.

In some possible implementations, the method further includes: configuring the second low-power wake-up signal.

In some possible implementations, the method further includes: configuring the second low-power wake-up signal including:
configuring the second frequency-domain resource based on the second bandwidth part.

In some possible implementations, the method further includes: sending configuration information of the second low-power wake-up signal to the second user equipment.

In some possible implementations, the method further includes:
performing a first configuration and not performing a second configuration when a first bandwidth part and the second bandwidth part have an overlapping region, wherein the first configuration is configured to configure the first low-power wake-up signal, the second configuration is configured to configure the second low-power wake-up signal, the first bandwidth part is a candidate bandwidth part for configuring the first low-power wake-up signal, and the second bandwidth part is a candidate bandwidth part for configuring the second low-power wake-up signal.

In some possible implementations, the first bandwidth part is an entire or partial initial downlink bandwidth part (BWP), and the second bandwidth part is an entire or partial active BWP.

A second aspect provides a method for receiving a wake-up signal performed by a user equipment, including:
receiving a first low-power wake-up signal on a first frequency-domain resource when the user equipment is in a radio resource control (RRC) idle state or an RRC inactive state, and/or receiving a second low-power wake-up signal on a second frequency-domain resource when the user equipment is in an RRC connected state;
wherein the first low-power wake-up signal is configured to wake up a first user equipment, the second low-power wake-up signal is configured to wake up a second user equipment, the first user equipment is in the RRC idle state or RRC inactive state, the second user equipment is in the RRC connected state, and the first frequency-domain resource is different from the second frequency-domain resource.

In some possible implementations, the first frequency-domain resource and the second frequency-domain resource have no overlapping region.

In some possible implementations, the method further includes:
receiving configuration information of the first low-power wake-up signal and configuration information of the second low-power wake-up signal sent by a network device when the user equipment is in the RRC connected state.

In some possible implementations, the method further includes:
not expecting the network device to send configuration information of the second low-power wake-up signal when the user equipment is in the RRC connected state, an active bandwidth part (BWP) of the user equipment and an initial downlink BWP have an overlapping region, and the user equipment receives configuration information of the first low-power wake-up signal.

In some possible implementations, the method further includes:
receiving configuration information of the second low-power wake-up signal sent by the network device when the user equipment is in the RRC connected state, an active bandwidth part (BWP) of the user equipment and an initial downlink BWP have an overlapping region, and the user equipment does not receive configuration information of the first low-power wake-up signal.

A third aspect provides a device for sending wake-up signals configured in a network device, including:
a transceiver module, configured to send a first low-power wake-up signal to a first user equipment on a first frequency-domain resource, and/or send a second low-power wake-up signal to a second user equipment on a second frequency-domain resource,
wherein the first low-power wake-up signal is configured to wake up the first user equipment, the second low-power wake-up signal is configured to wake up the second user equipment, the first user equipment is in a radio resource control (RRC) idle state or an RRC inactive state, the second user equipment is in an RRC connected state, and the first frequency-domain resource is different from the second frequency-domain resource.

A fourth aspect provides a device for receiving a wake-up signal configured in a user equipment, including:
a transceiver module configured to receive a first low-power wake-up signal on a first frequency-domain resource when the user equipment is in a radio resource control (RRC) idle state or an RRC inactive state, and/or receive a second low-power wake-up signal on a second frequency-domain resource when the user equipment is in an RRC connected state;
wherein the first low-power wake-up signal is configured to wake up a first user equipment, the second low-power wake-up signal is configured to wake up a second user equipment, the first user equipment is in the RRC idle state or RRC inactive state, the second user equipment is in the RRC connected state, and the first frequency-domain resource is different from the second frequency-domain resource.

A fifth aspect provides an electronic device including a processor and a memory, wherein
the memory is configured to store a computer program; and
the processor is configured to execute the computer program to implement the first aspect or any possible design thereof.

A sixth aspect provides an electronic device including a processor and a memory, wherein
the memory is configured to store a computer program; and
the processor is configured to execute the computer program to implement the second aspect or any possible design thereof.

A seventh aspect provides a computer-readable storage medium having instructions stored thereon that, when being invoked and executed on a computer, cause the computer to perform the first aspect or any possible design thereof.

An eight aspect provides a computer-readable storage medium having instructions stored thereon that, when being invoked and executed on a computer, cause the computer to perform the second aspect or any possible design thereof.

A ninth aspect provides a communication system including a user equipment and a network device, the network device is configured to perform the first aspect or any possible design thereof, and the user equipment is configured to perform the second aspect or any possible design thereof.

### BRIEF DESCRIPTION OF THE DRAWINGS

The accompanying drawings illustrated herein are used to provide a further understanding of embodiments of the present disclosure and form a part of the present disclosure. The embodiments of the present disclosure and their illustrations are used to explain the embodiments of the present disclosure and do not constitute an undue limitation of the embodiments of the present disclosure. In the accompanying drawings:

FIG. 1 is a schematic diagram of a radio communication system architecture provided by an embodiment of the present disclosure;

FIG. 2 is an interactive schematic diagram of sending and receiving a wake-up signal provided by an embodiment of the present disclosure;

FIG. 3 is another interactive schematic diagram of sending and receiving a wake-up signal provided by an embodiment of the present disclosure;

FIG. 4 is another interactive schematic diagram of sending and receiving a wake-up signal provided by an embodiment of the present disclosure;

FIG. 5 is an interactive schematic diagram of sending and receiving a wake-up signal provided by an embodiment of the present disclosure;

FIG. 6 is another interactive schematic diagram of sending and receiving a wake-up signal provided by an embodiment of the present disclosure;

FIG. 7 is another interactive schematic diagram of sending and receiving a wake-up signal provided by an embodiment of the present disclosure;

FIG. 8 is another interactive schematic diagram of sending and receiving a wake-up signal provided by an embodiment of the present disclosure;

FIG. 9 is another interactive schematic diagram of sending and receiving a wake-up signal provided by an embodiment of the present disclosure;

FIG. 10 is a flowchart of sending a wake-up signal provided by an embodiment of the present disclosure;

FIG. 11 is another flowchart of sending a wake-up signal provided by an embodiment of the present disclosure;

FIG. 12 is another flowchart of sending a wake-up signal provided by an embodiment of the present disclosure;

FIG. 13 is another flowchart of sending a wake-up signal provided by an embodiment of the present disclosure;

FIG. 14 is another flowchart of sending a wake-up signal provided by an embodiment of the present disclosure;

FIG. 15 is another flowchart of sending a wake-up signal provided by an embodiment of the present disclosure;

FIG. 16 is another flowchart of sending a wake-up signal provided by an embodiment of the present disclosure;

FIG. 17 is another flowchart of sending a wake-up signal provided by an embodiment of the present disclosure;

FIG. 18 is a flowchart of receiving a wake-up signal provided by an embodiment of the present disclosure;

FIG. 19 is another flowchart of receiving a wake-up signal provided by an embodiment of the present disclosure;

FIG. 20 is another flowchart of receiving a wake-up signal provided by an embodiment of the present disclosure;

FIG. 21 is another flowchart of receiving a wake-up signal provided by an embodiment of the present disclosure;

FIG. 22 is a structural diagram of a device for sending a wake-up signal provided by an embodiment of the present disclosure;

FIG. 23 is another structural diagram of a device for sending a wake-up signal provided by an embodiment of the present disclosure;

FIG. 24 is a structural diagram of a device for receiving a wake-up signal provided by an embodiment of the present disclosure; and

FIG. 25 is another structural diagram of a device for receiving a wake-up signal provided by an embodiment of the present disclosure.

### DETAILED DESCRIPTION

Embodiments of the present disclosure are further described in conjunction with the accompanying drawings and detailed implementations.

Embodiments will be described herein in detail, examples of which are represented in the accompanying drawings. When the following description relates to the accompanying drawings, the same numerals in the different figures indicate the same or similar elements unless otherwise indicated. The implementations described in the following embodiments do not represent all implementations consistent with the embodiments of the present disclosure. Rather, they are only examples of devices and methods consistent with some aspects of the present disclosure as detailed in the attached claims.

The term used in the embodiments of the present disclosure is used solely for describing particular embodiments and is not intended to limit the embodiments of the present disclosure. The singular forms of “a”, “an”, “said” and “the” used in the embodiments of the present disclosure and the appending claims are also intended to encompass the plural forms, unless clearly indicated otherwise in the context. It is also to be understood that the term “and/or” as used herein refers to and encompasses any or all possible combinations of one or more of the associated listed items.

It is to be understood that while the terms first, second, third, etc. may be used in the embodiments of the present disclosure to describe various information, such information should not be limited to these terms. These terms are only used to distinguish the same type of information from one another. For example, without departing from the scope of the embodiments of the present disclosure, first information may also be referred to as second information, and similarly, the second information may be referred to as the first information. Depending on the context, the word “if” as used herein may be interpreted as “at the time of . . . ” or “when . . . ” or “in response to determining”.

Embodiments of the present disclosure will be described in details below, examples of which are shown in the accompanying drawings, and throughout which, the same or similar numerals indicate the same or similar elements. The embodiments described below with reference to the accompanying drawings are exemplary and are intended to explain the present disclosure but not to be construed as a limitation of the present disclosure.

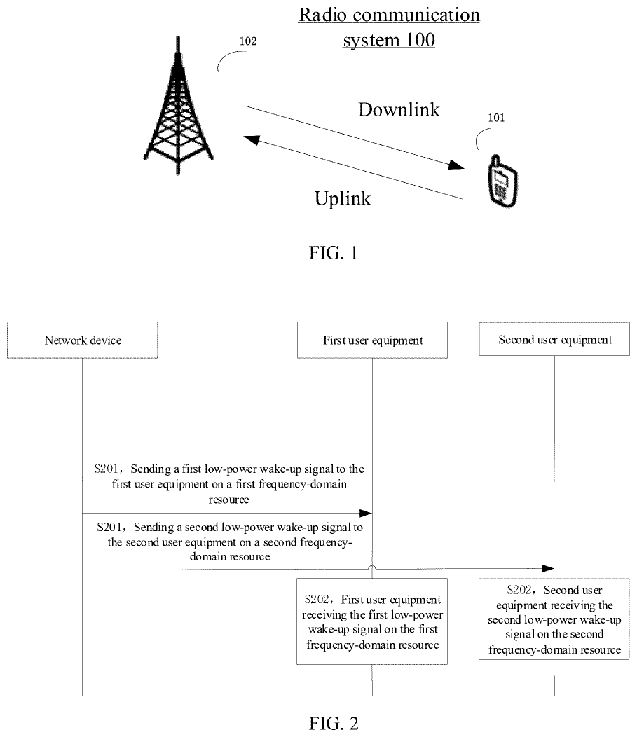

As shown in FIG. 1, the method provided by embodiments of the present disclosure may be applied to a radio communication system 100, which may include a user equipment 101 and a network device 102. It is to be noted that the radio communication system 100 may also include other devices, and the present disclosure does not limit the devices included in the radio communication system 100.

It is to be understood that the above radio communication system 100 may be applicable to both a low frequency scenario and a high frequency scenario. The application scenarios of the radio communication system 100 include, but are not limited to, a long term evolution (LTE) system, an LTE frequency division duplex (FDD) system, an LTE time division duplex (TDD) system, a worldwide interoperability for micro wave access (WiMAX) communication system, a cloud radio access network (CRAN) system, a future 5th-generation (5G) system, a new radio (NR) communication system, a future evolved public land mobile network (PLMN) system or the like.

The user equipment 101 shown above may be a terminal, an access user equipment, a user equipment unit, a user equipment station, a mobile station (MS), a remote station, a remote user equipment, a mobile user equipment (mobile terminal), a wireless communication device, a user equipment agent, or the like. The user equipment 101 may have a wireless transceiver function, which can communicate (e.g., wirelessly) with one or more network devices in one or more communication systems and receive network services provided by the network devices. The network device herein includes, but is not limited to, the network device 102 as shown.

The user equipment 101 may be a cellular telephone, a cordless telephone, a session initiation protocol (SIP) telephone, a wireless local loop (WLL) station, a personal digital assistant (PDA) device, a handheld device with a wireless communication function, a computing device or other processing device connected to a wireless modem, an in-vehicle device, a wearable device, a user equipment in a future 5G network, a user equipment in a future evolved PLMN network, or the like.

For example, the network device 102 may be an access network device (or access network site). The access network device refers to a device having a network access function, such as a radio access network (RAN) base station and the like. The network device 102 may specifically include a base station (BS), or include a base station and a radio resource management device for controlling the base station, and the like. The network device 102 may further include a relay station (relay device), an access point, and a base station in a future 5G network, a base station in a future evolved PLMN network, a NR base station, or the like. The network device 102 may also be a communication chip having a communication module.

The user equipment 101 in the present disclosure involves two types, i.e., a first user equipment and a second user equipment. The first user equipment is in an RRC (Radio Resource Control) idle state or RRC inactive state, and the second user equipment is in an RRC connected state. There may be one or more first user equipments and/or one or more second user equipments within a cell.

An embodiment of the present disclosure provides a method for sending and receiving a wake-up signal. FIG. 2 is an interactive schematic diagram illustrating a method for sending and receiving a wake-up signal provided by an embodiment of the present disclosure. As shown in FIG. 2, the method includes S201-S202.

In S201, a network device sends a first low-power wake-up signal to a first user equipment on a first frequency-domain resource, and/or sends a second low-power wake-up signal to a second user equipment on a second frequency-domain resource.

In an embodiment of the present disclosure, the first frequency-domain resource is a frequency-domain resource occupied by the first low-power wake-up signal, and the second frequency-domain resource is a frequency-domain resource occupied by the second low-power wake-up signal. The first frequency-domain resource and the second frequency-domain resource are different.

The first low-power wake-up signal is configured to wake up the first user equipment, which is in a radio resource control (RRC) idle state or RRC inactive state, and the second low-power wake-up signal is configured to wake up the second user equipment, which is in an RRC connected state. That is, the low-power wake-up signal for waking up the UE in the RRC connected state is different from the low-power wake-up signal for waking up the UE not in the RRC connected state. It can be seen that the network device may configure different low-power wake-up signals for user equipments in different RRC states. In an embodiment, different frequency-domain resources are used to send different low-power wake-up signals.

In some possible implementations, the first low-power wake-up signal and the second low-power wake-up signal are different.

For example, both the first low-power wake-up signal and the second low-power wake-up signal indicate wake-up based on a UE group, however the manners in which the UE groups thereof are divided may be different, and the numbers of UE groups thereof may also be different, therefore the numbers of bits carried by the first and second low-power wake-up signals also are different.

For another example, the first low-power wake-up signal indicates wake-up based on a UE group, and the second low-power wake-up signal indicates wake-up not based on a UE group.

In some possible implementations, a specific UE at a given time point may be in one of an RRC idle state, an RRC inactive state, or an RRC connected state. When the specific UE is in the RRC idle state or RRC inactive state at a first time point, the UE is the first user equipment at the first time point; and when the specific UE is in the RRC connected state at a second time point, the UE is the second user equipment at the second time point. However, within a single cell, there may be a plurality of user equipments in different respective RRC states such as RRC idle state, RRC inactive state, and RRC connected state.

It is to be understood that the first user equipment and the second user equipment may refer to different user equipment within the same cell, which are in different RRC states. Alternatively, the first user equipment and the second user equipment may also refer to the same user equipment in different RRC states at different time points.

In some possible implementations, the network device broadcasts the first low-power wake-up signal on the first frequency-domain resource. For example, the network device sends a broadcast signal on the first frequency-domain resource, and the broadcast signal includes the first low-power wake-up signal.

In some possible implementations, the network device sends the second low-power wake-up signal on the second frequency-domain resource via an RRC connection. For example, the network device sends the second low-power wake-up signal to a specific second UE via an established RRC connection between the network device and the specific second UE.

In S202, the first user equipment receives the first low-power wake-up signal on the first frequency-domain resource, and/or the second user equipment receives the second low-power wake-up signal on the second frequency-domain resource.

If the first user equipment/second user equipment is currently in a low-power state (e.g., sleep state), the first user equipment/second user equipment may receive the low-power wake-up signal (first low-power wake-up signal or second low-power wake-up signal) through a low-power wake-up receiver (LP WUR). Furthermore, the first user equipment may receive the first low-power wake-up signal on the first frequency-domain resource. The second user equipment may receive the second low-power wake-up signal on the second frequency-domain resource. Subsequently, the first user equipment wakes up a main transceiver after receiving the first wake-up signal to process uplink data and downlink data. The second user equipment wakes up a main transceiver after receiving the second wake-up signal to process uplink data and downlink data.

In some embodiments, a user equipment may distinguish between configuration information of different low-power wake-up signals, i.e., identify whether the configuration information of the received low-power wake-up signal is configuration information of the first low-power wake-up signal or configuration information of the second low-power wake-up signal. For example, a specific user equipment in an RRC connected state may learn that the network device has configured two types of low-power wake-up signals. For example, the specific user equipment may obtain the configuration information of the first low-power wake-up signal via a broadcast signal and the configuration information of the second low-power wake-up signal via an RRC connection. The configuration of the first low-power wake-up signal indicates the first frequency-domain resource, and the configuration of the second low-power wake-up signal indicates the second frequency-domain resource. Therefore, the specific user equipment may learn that the first frequency-domain resource corresponds to the first low-power wake-up signal, and that the second frequency-domain resource corresponds to the second low-power wake-up signal. Since the specific user equipment is currently in the RRC connected state and belongs to the second user equipment, it may not receive the first low-power wake-up signal via the first frequency-domain resource, but receives the second low-power wake-up signal via the second frequency-domain resource and wake up the main receiver based on the second low-power wake-up signal. As can be seen, even if the second user equipment receives configurations of different low-power wake-up signals, it can distinguish between the different low-power wake-up signals, enabling the network device to configure a plurality of low-power wake-up signals.

In the method provide by the embodiment of the present disclosure, the network device sends the first low-power wake-up signal to the first user equipment on the first frequency-domain resource to wake up the main transceiver of the first user equipment, and sends the second low-power wake-up signal to the second user equipment on the second frequency-domain resource to wake up the main transceiver of the second user equipment. By sending different types of low-power wake-up signals to the user equipments in different RRC states on different frequency-domain resources, the network device respectively wakes up user equipments in different RRC states and achieves coexistence of the first low-power wake-up signal and the second low-power wake-up signal. This avoids mutual interference between two wake-up signals and thus prevents the UE from being interfered by another wake-up signal when receiving a specific low-power wake-up signal.

In some possible implementations, the first frequency-domain resource and the second frequency-domain resource do not have any overlapping regions. The first frequency-domain resource and the second frequency-domain resource do not have any overlapping regions, which means that no resource in the first frequency-domain resource belongs to the second frequency-domain resource, and/or no resource in the second frequency-domain resource belongs to the first frequency-domain resource.

In the case where there is no overlapping region between the first frequency-domain resource and the second frequency-domain resource, the implementation for sending and receiving the wake-up signal may refer to the following embodiments.

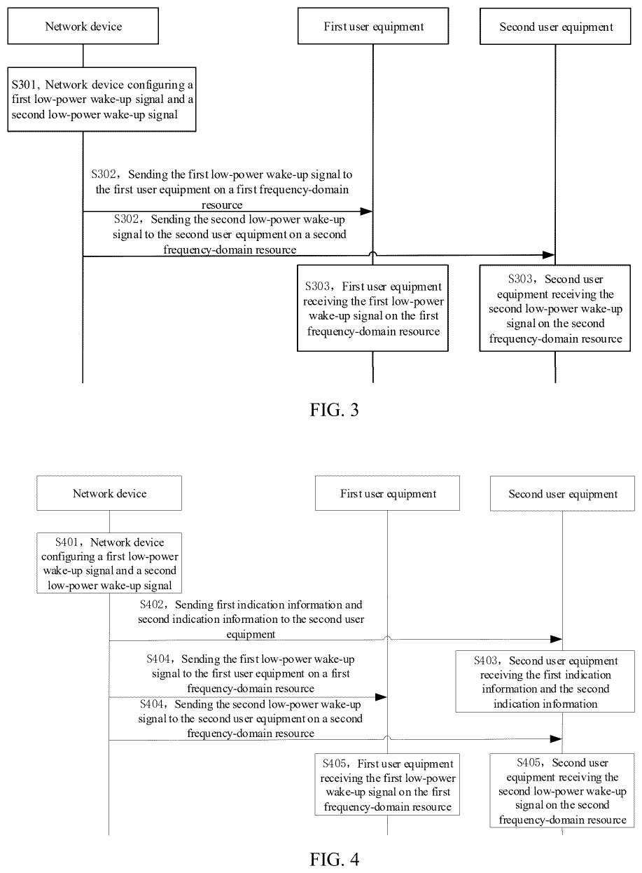

FIG. 3 is another interactive schematic diagram of sending and receiving wake-up signals provided by the present disclosure. As shown in FIG. 3, the method includes S301-S303.

In S301, a network device configures a first low-power wake-up signal and a second low-power wake-up signal.

In some possible implementations, configuring the first low-power wake-up signal includes: determining first configuration information and performing the first configuration information. Configuring the second low-power wake-up signal includes: determining second configuration information and performing the second configuration information.

In some possible implementations, the first configuration information and the second configuration information are pre-set configuration information. Configuring the first low-power wake-up signal includes performing the first configuration information, and configuring the second low-power wake-up signal includes performing the second configuration information.

The first configuration information is the configuration information of the first low-power wake-up signal, and the second configuration information is the configuration information of the second low-power wake-up signal.

In an example:
the first configuration information includes at least one of a first time-domain resource, a UE group parameter or a first frequency-domain resource for sending the first low-power wake-up signal; and
the second configuration information includes at least one of a second time-domain resource or a second frequency-domain resource for sending the second low-power wake-up signal, or includes a time-domain resource, a UE group parameter and a frequency-domain resource of the second low-power wake-up signal.

There is no overlapping region between the first frequency-domain resource and the second frequency-domain resource.

In S302, the network device sends the first low-power wake-up signal to a first user equipment on a first frequency-domain resource and sends the second low-power wake-up signal to a second user equipment on a second frequency-domain resource.

The details of S302 are the same as that of S201 and may refer to S201, which are not repeated here.

In S303, the first user equipment receives the first low-power wake-up signal on the first frequency-domain resource, and/or the second user equipment receives the second low-power wake-up signal on the second frequency-domain resource.

The implementations of S302-S303 are analogous to those of S201-S202, which are not repeated here.

In the embodiments of the present disclosure, for the case where there is no overlapping region between the first frequency-domain resource and the second frequency-domain resource, the first configuration and the second configuration are performed to determine the first frequency-domain resource and the second frequency-domain resource, enabling the network device to send different low-power wake-up signals to user equipments in different states on different frequency-domain resources, thereby achieving the coexistence of the first low-power wake-up signal and the second low-power wake-up signal.

FIG. 4 is another interactive schematic diagram of sending and receiving a wake-up signal provided by an embodiment of the present disclosure. As shown in FIG. 4, the method includes S401-S405.

In S401, a network device configures a first low-power wake-up signal and a second low-power wake-up signal.

The details of S401 are the same as those of S301 and may refer to S301, which are not repeated herein.

In S402, the network device sends the first indication information and second indication information to a second user equipment.

The first indication information is configured to indicate configuration information of the first low-power wake-up signal, and the second indication information is configured to indicate configuration information of the second low-power wake-up signal.

S402 may also be that the network device sends the configuration information of the first low-power wake-up signal and the configuration information of the second low-power wake-up signal to the second user equipment.

In S403, the second user equipment receives the first indication information and the second indication information.

S403 may also be that the second user equipment receives the configuration information of the first low-power wake-up signal and the configuration information of the second low-power wake-up signal.

When performing a first configuration and a second configuration, the network device sends the first indication information and the second indication information to the second user equipment, i.e., the UE in the RRC connected state, so that the UE in the RRC connected state may obtain the configuration information of the first low-power wake-up signal based on the first indication information, for example, a first frequency-domain resource where the first low-power wake-up signal is located, and obtain the configuration information of the second low-power wake-up signal based on the second indication information, for example, a second frequency-domain resource where the second low-power wake-up signal is located.

In S404, the network device sends the first low-power wake-up signal to the first user equipment on the first frequency-domain resource and sends the second low-power wake-up signal to the second user equipment on the second frequency-domain resource.

The details of S404 are the same as those of S201 and may refer to S201, which are not repeated herein.

In S405, the first user equipment receives the first low-power wake-up signal on the first frequency-domain resource, and the second user equipment receives the second low-power wake-up signal on the second frequency-domain resource.

The implementations of S404-S405 are analogous to those of S201-S202, and are not repeated herein.

In the embodiments of the present disclosure, for the case where there is no overlapping region between the first frequency-domain resource and the second frequency-domain resource, the first configuration and the second configuration are performed to determine the first frequency-domain resource and the second frequency-domain resource, and the first indication information and the second indication information are sent to the UE in the RRC connected state, enabling the UE to obtain the configuration information of the first low-power wake-up signal and the second low-power wake-up signal and thus smoothly receive the configuration information of the first low-power wake-up signal and the second low-power wake-up signal.

In some possible implementations, a first bandwidth part is a candidate bandwidth part for configuring the first low-power wake-up signal, and a second bandwidth part is a candidate bandwidth part for configuring the second low-power wake-up signal, i.e., all or part of the first bandwidth part is configured to send the first low-power wake-up signal, and all or part of the second bandwidth part is configured to send the second low-power wake-up signal.

In some possible implementations, the first bandwidth part and the second bandwidth part are default.

For example, the first bandwidth part is all or part of the initial downlink bandwidth (initial DL BWP), and the second bandwidth part is all or part of an active BWP.

The first bandwidth part and the second bandwidth part may have an overlapping region. In such case, the implementation of sending and receiving the wake-up signal refers to the following embodiment.

An embodiment of the present disclosure provides a processing method including that: the network device does not configure the second low-power wake-up signal when the first bandwidth part and the second bandwidth part have an overlapping region.

In some possible implementations, the network device does not configure the second low-power wake-up signal but configures the first low-power wake-up signal when there is an overlapping region between the first bandwidth part and the second bandwidth part.

The process of this implementation may include that: after determining that there is an overlapping region between the first bandwidth part and the second bandwidth part, the network device configures the first low-power wake-up signal but does not configure the second low-power wake-up signal.

In some possible implementations, the network device does not configure the second low-power wake-up signal when there is an overlapping region between the first bandwidth part and the second bandwidth part and the first low-power wake-up signal has already been configured.

The process of this implementation may include the following steps: the network device first determines that there is an overlapping region between the first bandwidth part and the second bandwidth part, then determines that the first low-power wake-up signal has already been configured, and thus does not configure the second low-power wake-up signal.

In some possible implementations, the network device does not configure the second low-power wake-up signal and does not configure the first low-power wake-up signal when there is an overlapping region between the first bandwidth part and the second bandwidth part.

The process of this implementation may include that: the network device determines that there is an overlapping region between the first bandwidth part and the second bandwidth part, and then does not configure any low-power wake-up signals.

In the embodiments of the present disclosure, when there is an overlapping region between the first bandwidth part and the second bandwidth part, in order to avoid the possibility of sending different information on the same frequency-domain resource, the network device does not configure the second low-power wake-up signal, thereby ensuring the accuracy of data transmission by sacrificing the function of waking up the second user equipment.

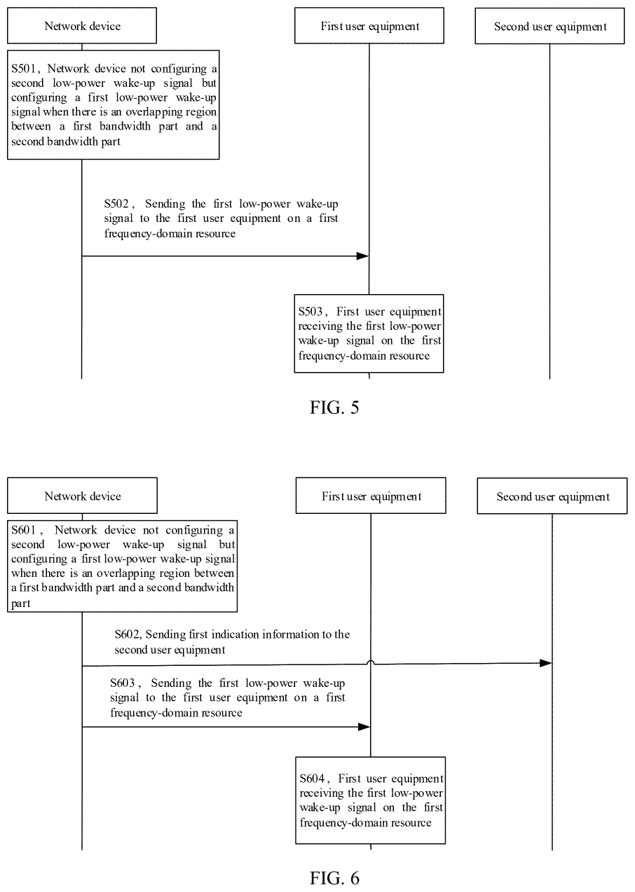

FIG. 5 is another interactive schematic diagram of sending and receiving a wake-up signal provided by an embodiment of the present disclosure. As shown in FIG. 5, the method includes S501-S503.

In S501, when there is an overlapping region between a first bandwidth part and a second bandwidth part, a network device does not configure a second low-power wake-up signal but configures a first low-power wake-up signal.

In some possible implementations, configuring the first low-power wake-up signal includes: configuring a first frequency-domain resource based on the first bandwidth part, for example, configuring the first frequency-domain resource within the first bandwidth part.

In some possible implementations, after determining that the first bandwidth part and the second bandwidth part have an overlapping region, the network device configures the first low-power wake-up signal and does not configure the second low-power wake-up signal.

In some possible implementations, the network device first determines that the first bandwidth part and the second bandwidth part have an overlapping region, then determines that the first low-power wake-up signal has been configured, and does not configure the second low-power wake-up signal. That is, the network device does not configure the second low-power wake-up signal when the first bandwidth part and the second bandwidth part have an overlapping region and the first low-power wake-up signal has been configured.

In S502, the network device sends the first low-power wake-up signal to a first user equipment on the first frequency-domain resource.

Since the first low-power wake-up signal is configured and the second low-power wake-up signal is not configured, the first low-power wake-up signal may be sent to the first user equipment on the first frequency-domain resource without sending the second low-power wake-up signal to the second user equipment.

The first frequency-domain resource is a frequency-domain resource occupied by the first low-power wake-up signal.

The first low-power wake-up signal is configured to wake up the first user equipment, which is in a radio resource control (RRC) idle state or RRC inactive state.

In some possible implementations, a specific UE at a given time point may be in one of an RRC idle state, an RRC inactive state, or an RRC connected state. When the specific UE is in the RRC idle state or RRC inactive state at a first time point, the UE is the first user equipment at the first time point.

In some possible implementations, the network device broadcasts the first low-power wake-up signal on the first frequency-domain resource, for example, the network device sends a broadcast signal on the first frequency-domain resource, and the broadcast signal includes the first low-power wake-up signal.

In S503, the first user equipment receives the first low-power wake-up signal on the first frequency-domain resource.

If the first user equipment is currently in a low-power state (e.g., sleep state), the first user equipment may receive the low-power wake-up signal through a low-power wake-up receiver (LP WUR). Furthermore, the first user equipment may receive the first low-power wake-up signal on the first frequency-domain resource. Subsequently, the first user equipment wakes up a main transceiver after receiving the first wake-up signal to process uplink data and downlink data.

In the embodiments of the present disclosure, when there is an overlapping region between the first bandwidth part and the second bandwidth part, in order to prevent the possibility of sending different information on the same frequency-domain resource, the network device only configures the first low-power wake-up signal and does not configure the second low-power wake-up signal. By sacrificing the function of waking up the second user equipment, the accuracy of data transmission is ensured.

FIG. 6 is another interactive diagram of sending and receiving a wake-up signal provided by an embodiment of the present disclosure. As shown in FIG. 6, the method includes steps S601-S604.

In S601, when there is an overlapping region between a first bandwidth part and a second bandwidth part, a network device does not configure a second low-power wake-up signal but configures a first low-power wake-up signal.

The details of S601 are the same as those of S501 and may refer to S501, which will not be repeated herein.

In S602, the network device sends the first indication information to a second user equipment.

The first indication information is configured to indicate configuration information of the first low-power wake-up signal.

S602 may also be that the network device sends the configuration information of the first low-power wake-up signal to the second user equipment.

In some possible implementations, the network device broadcasts the first indication information, and the second user equipment obtains the first indication information by receiving the broadcast.

In S602, the network device does not send second indication information to the second user equipment, where the second indication information is configured to indicate configuration information of the second low-power wake-up signal.

In S603, the network device sends the first low-power wake-up signal to a first user equipment on a first frequency-domain resource.

Since the first low-power wake-up signal is configured and the second low-power wake-up signal is not configured, the first low-power wake-up signal may be sent to the first user equipment on the first frequency-domain resource without sending the second low-power wake-up signal.

The details of S603 are the same as that of S502 and are not repeated herein.

In S604, the first user equipment receives the first low-power wake-up signal on the first frequency-domain resource.

In the embodiments of the present disclosure, when there is an overlapping region between the first bandwidth part and the second bandwidth part, in order to avoid the possibility of sending different information on the same frequency-domain resource, the network device only configures the first low-power wake-up signal but does not configure the second low-power wake-up signal. By sacrificing the function of waking up the second user equipment, the accuracy of data transmission is ensured.

An embodiment of the present disclosure provides a processing method, which includes that: the network device does not configure the first low-power wake-up signal when there is an overlapping region between the first bandwidth part and the second bandwidth part.

In some possible implementations, the network device does not configure the first low-power wake-up signal but configures the second low-power wake-up signal when there is an overlapping region between the first bandwidth part and the second bandwidth part.

The process of this implementation may include that: after determining that the first bandwidth part and the second bandwidth part have an overlapping region, the network device configures the second low-power wake-up signal but does not configure the first low-power wake-up signal.

In some possible implementations, the network device does not configure the first low-power wake-up signal when the first bandwidth part and the second bandwidth part have an overlapping region and the second low-power wake-up signal has been configured.

The process of this implementation may include that: the network device first determines that the first bandwidth part and the second bandwidth part have an overlapping region, then determines that the second low-power wake-up signal has been configured, and does not configure the first low-power wake-up signal.

In some possible implementations, the network device does not configure the first low-power wake-up signal and the second low-power wake-up signal when the first bandwidth part and the second bandwidth part have an overlapping region.

The process of this implementation may include that: after determining that the first bandwidth part and the second bandwidth part have an overlapping region, the network device does not configure any low-power wake-up signals.

In the embodiments of the present disclosure, when there is an overlapping region between the first bandwidth part and the second bandwidth part, in order to avoid the possibility of sending different information on the same frequency-domain resource, the network device does not configure the first low-power wake-up signal, thereby ensuring the accuracy of data transmission by sacrificing the function of waking up the first user equipment.

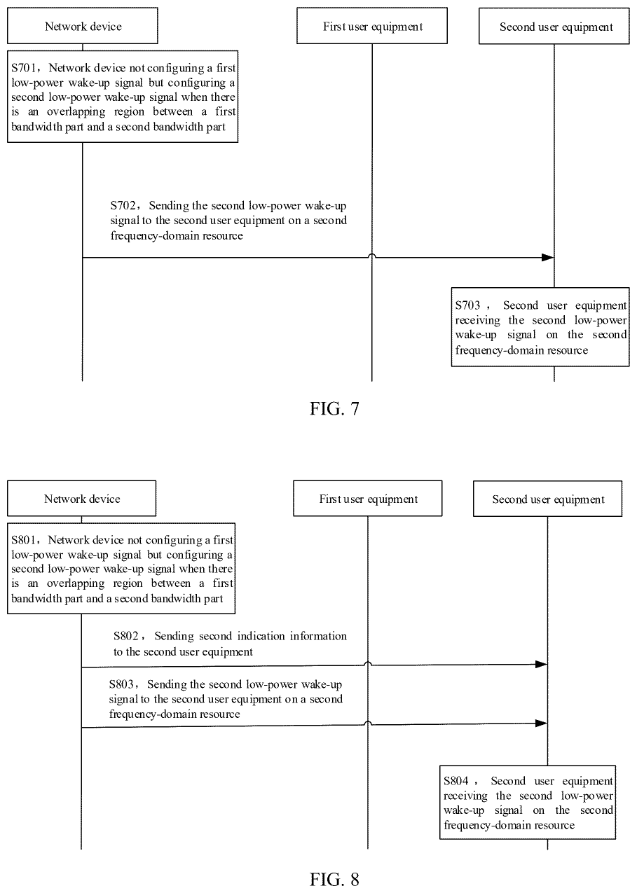

FIG. 7 is another interactive diagram of sending and receiving a wake-up signal provided by an embodiment of the present disclosure. As shown in FIG. 7, the method includes S701-S703.

In S701, when there is an overlapping region between a first bandwidth part and a second bandwidth part, a network device does not configure a first low-power wake-up signal but configures a second low-power wake-up signal.

In some possible implementations, configuring the second low-power wake-up signal includes: configuring a second frequency-domain resource based on the second bandwidth part, for example, configuring the second frequency-domain resource within the second bandwidth part.

In some possible implementations, after determining that the first bandwidth part and the second bandwidth part have an overlapping region, the network device configures the second low-power wake-up signal but does not configure the first low-power wake-up signal.

In some possible implementations, the network device first determines that the first bandwidth part and the second bandwidth part have an overlapping region, then determines that the second low-power wake-up signal has been configured, and thus does not configure the first low-power wake-up signal. That is, the network device does not configure the first low-power wake-up signal when the first bandwidth part and the second bandwidth part have an overlapping region and the second low-power wake-up signal has been configured.

In S702, the network device sends the second low-power wake-up signal to a second user equipment on a second frequency-domain resource.

Since the second low-power wake-up signal is configured and the first low-power wake-up signal is not configured, the second low-power wake-up signal may be sent to the second user equipment on the second frequency-domain resource without sending the first low-power wake-up signal.

The second frequency-domain resource is a frequency-domain resource occupied by the second low-power wake-up signal.

The second low-power wake-up signal is configured to wake up the second user equipment, which is in a radio resource control (RRC) connected state.

In some possible implementations, a specific UE at a given time point may be in one of an RRC idle state, an RRC inactive state, or an RRC connected state. When the specific UE is in the RRC connected state at a first time point, the UE is the second user equipment at the first time point.

In some possible implementations, the network device sends the second low-power wake-up signal on the second frequency-domain resource via an RRC connection, for example, the network device sends the second low-power wake-up signal to a specific second UE via an established RRC connection between the network device and the specific second UE.

In S703, the second user equipment receives the second low-power wake-up signal on the second frequency-domain resource.

If the second user equipment is currently in a low-power state (e.g., sleep state), the second user equipment may receive the low-power wake-up signal through a low-power wake-up receiver (LP WUR). Furthermore, the second user equipment may receive the second low-power wake-up signal on the second frequency-domain resource. Subsequently, the second user equipment wakes up a main transceiver after receiving the second wake-up signal to process uplink data and downlink data.

In the embodiments of the present disclosure, when there is an overlapping region between the first bandwidth part and the second bandwidth part, in order to avoid the possibility of sending different information on the same frequency-domain resource, the network device only configure the second low-power wake-up signal without configuring the first low-power wake-up signal, thereby ensuring the accuracy of data transmission by sacrificing the function of waking up the first user equipment.

FIG. 8 illustrates another interactive schematic diagram of sending and receiving a wake-up signal provided by an embodiment of the present disclosure. As shown in FIG. 8, the method includes S801-S804.

In S801, when there is an overlapping region between a first bandwidth part and a second bandwidth part, a network device does not configure a first low-power wake-up signal but configures a second low-power wake-up signal.

The details of S801 are the same as those of S701 and refer to S701, which are not repeated herein.

In S802, the network device sends second indication information to a second user equipment.

In S802, the network device does not send the first indication information to the second user equipment, where the first indication information is configured to indicate configuration information of the first low-power wake-up signal.

S802 may also be that the network device sends configuration information of the second low-power wake-up signal to the second user equipment.

In S803, the network device sends a second low-power wake-up signal to the second user equipment on a second frequency-domain resource.

Since the second low-power wake-up signal is configured and the first low-power wake-up signal is not configured, the second low-power wake-up signal may be sent to the second user equipment on the second frequency-domain resource without sending the first low-power wake-up signal.

The details of S803 are the same as those of S702, which are not repeated herein.

In S804, the second user equipment receives the second low-power wake-up signal on the second frequency-domain resource.

In the embodiments of the present disclosure, when there is an overlapping region between the first bandwidth part and the second bandwidth part, in order to avoid the possibility of sending different information on the same frequency-domain resource, the network device only configure the second low-power wake-up signal without configuring the first low-power wake-up signal, thereby ensuring the accuracy of data transmission by sacrificing the function of waking up the first user equipment.

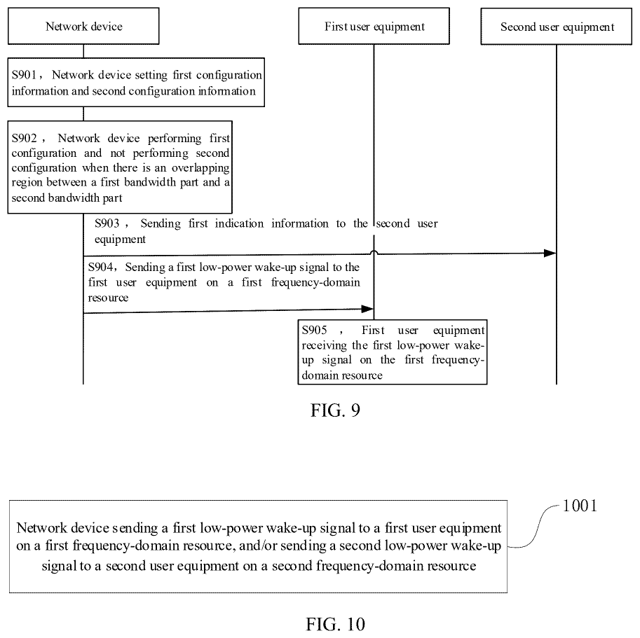

FIG. 9 illustrates another interactive schematic diagram of sending and receiving a wake-up signal provided by an embodiment of the present disclosure. As shown in FIG. 9, the method includes steps S901-S904.

In S901, a network device sets first configuration information and second configuration information.

The first configuration information is configuration information for the first low-power wake-up signal, and the second configuration information is configuration information for the second low-power wake-up signal.

In an example, the first configuration information includes at least one of a first time-domain resource, a UE group parameter or a first frequency-domain resource for sending the first low-power wake-up signal.

The second configuration information includes at least one of a second time-domain resource or a second frequency-domain resource for sending the second low-power wake-up signal, or includes a time-domain resource, a UE group parameter and a frequency-domain resource of the second low-power wake-up signal.

The first frequency-domain resource in the first configuration information is located in a first bandwidth part, and the second frequency-domain resource in the second configuration information is located in a second bandwidth part. The first bandwidth part is a candidate bandwidth part for configuring the first low-power wake-up signal, and the second bandwidth part is a candidate bandwidth part for configuring the second low-power wake-up signal.

S901 may also be described as that the network device sets the configuration information for the first low-power wake-up signal and the configuration information for the second low-power wake-up signal.

In S902, when there is an overlapping region between the first bandwidth part and the second bandwidth part, the network device performs first configuration and does not perform second configuration.

Performing the first configuration includes performing configuration based on the first configuration information, and performing the second configuration includes performing configuration based on the second configuration information.

In step S902, when there is an overlapping region between the first bandwidth part and the second bandwidth part, and both the first configuration information and the second configuration information have been set, the network device selects to perform only one configuration, for example, selects to perform the first configuration and not to perform the second configuration. It is to be understood that since the first configuration is for waking up the first user equipment, the second configuration is for waking up the second user equipment, and the first user equipment is in the RRC idle state or inactive state, the first user equipment may only monitor the first low-power wake-up signal sent by the network device, and may not learn the existence of the configuration of the second low-power wake-up signal. The second user equipment is in the RRC connected state, may receive a downlink signal via a RRC link, and may also monitor a broadcast signal, and thus may learn the existence of both configurations of the first low-power wake-up signal and the second low-power wake-up signal. When the UE learns the existence of both low-power wake-up signals and that the first bandwidth part and the second bandwidth part have an overlapping region, the UE may abandon monitoring of the second low-power wake-up signal according to a protocol specification, so the network device prioritizes performing the first configuration.

In S903, the network device sends first indication information to the second user equipment.

The first indication information is configured to indicate configuration information of the first low-power wake-up signal.

Since the network device has only performed the first configuration and not the second configuration, the network device in S903 does not send second indication information to the second user equipment. The second indication information is configured to indicate the configuration information of the second low-power wake-up signal.

S903 may also be that the network device sends the configuration information for the first low-power wake-up signal to the second user equipment.

In S904, the network device sends the first low-power wake-up signal to the first user equipment on the first frequency-domain resource.

In S905, the first user equipment receives the first low-power wake-up signal on the first frequency-domain resource.

In the embodiments of the present disclosure, when there is an overlapping region between the first bandwidth part and the second bandwidth part, in order to avoid the possibility of sending different information on the same frequency-domain resource, the network device only performs the first configuration information and does not perform the second configuration information when having been configured with both the first configuration information and the second configuration information, thereby ensuring the accuracy of data transmission by sacrificing the function of waking up the first user equipment.

In some possible implementations, when the network device sends a low-power wake-up signal, there may be three scenarios including:
a first scenario, sending both the first low-power wake-up signal and the second low-power wake-up signal;
a second scenario, sending the first low-power wake-up signal but not sending the second low-power wake-up signal; and
a third scenario, sending the second low-power wake-up signal but not sending the first low-power wake-up signal.

The following respectively describes corresponding embodiments based on the three scenarios.

An embodiment of the present disclosure provides another method for sending and receiving a wake-up signal, which includes that:
when there is no overlapping region between the first frequency-domain resource and the second frequency-domain resource, the network device sends the first low-power wake-up signal to the first user equipment on the first frequency-domain resource, and sends the second low-power wake-up signal to the second user equipment on the second frequency-domain resource.

The first low-power wake-up signal is configured to wake up the first user equipment, the second low-power wake-up signal is configured to wake up the second user equipment, the first user equipment is in a radio resource control (RRC) idle state or RRC inactive state, the second user equipment is in an RRC connected state, and the first frequency-domain resource is different from the second frequency-domain resource.

In some possible embodiments, before sending the first low-power wake-up signal to the first user equipment on the first frequency-domain resource and sending the second low-power wake-up signal to the second user equipment on the second frequency-domain resource, the method further includes: configuring the first low-power wake-up signal and the second low-power wake-up signal.

The method for configuring the first low-power wake-up signal is the same as that described in the previous embodiments, and the method for configuring the second low-power wake-up signal is the same as that described in the previous embodiments, which will not be repeated here.

In some possible implementations, the method further includes: sending the first indication information and the second indication information to the second user equipment, or sending configuration information for the first low-power wake-up signal and configuration information for the second low-power wake-up signal to the second user equipment.

An embodiment of the present disclosure provides another method for sending and receiving a wake-up signal, which includes that:
when there is an overlapping region between the first bandwidth part and the second bandwidth part, the network device does not configure the second low-power wake-up signal and configures the first low-power wake-up signal, and sends the first low-power wake-up signal to the first user equipment on the first frequency-domain resource.

In some possible implementations, configuring the first low-power wake-up signal includes: configuring the first frequency-domain resource based on the first bandwidth part, for example, configuring the first frequency-domain resource within the first bandwidth part.

The method for configuring the first low-power wake-up signal is the same as that described in the previous embodiments and is not repeated herein.

In some possible implementations, the method further includes: sending the first indication information to the second user equipment, or sending the configuration information for the first low-power wake-up signal to the second user equipment.

An embodiment of the present disclosure provides another method for sending and receiving a wake-up signal, which includes that:
when there is an overlapping region between the first bandwidth part and the second bandwidth part, the network device does not configure the first low-power wake-up signal and configures the second low-power wake-up signal, and sends the second low-power wake-up signal to the second user equipment on the second frequency-domain resource.

In some possible implementations, configuring the second low-power wake-up signal includes: configuring the second frequency-domain resource based on the second bandwidth part, for example, configuring the second frequency-domain resource within the second bandwidth part.

The method for configuring the second low-power wake-up signal is the same as that described in the previous embodiments and is not repeated here.

In some possible implementations, the method further includes: sending the second indication information to the second user equipment, or sending the configuration information for the second low-power wake-up signal to the second user equipment.

An embodiment of the present disclosure provides a method for sending a wake-up signal, performed by a network device. FIG. 10 is a flowchart illustrating a method for sending a wake-up signal provided by an embodiment of the present disclosure. As shown in FIG. 10, the method includes step 1001.

In step 1001, the network device sends a first low-power wake-up signal to a first user equipment on a first frequency-domain resource, and/or sends a second low-power wake-up signal to a second user equipment on a second frequency-domain resource.

In some possible implementations, there is no overlapping region between the first frequency-domain resource and the second frequency-domain resource.

The details of step 1001 are the same as that of S201 and may refer to S201, which are not repeated herein.

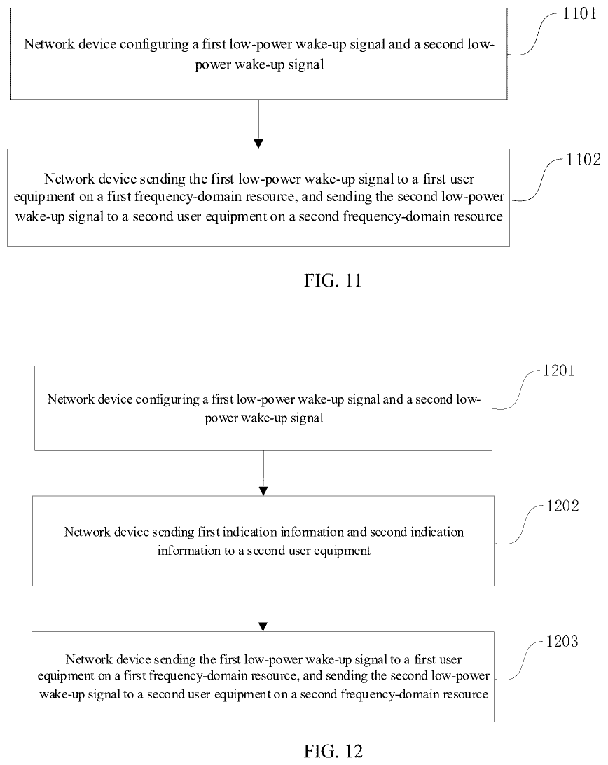

An embodiment of the present disclosure provides a method for sending a wake-up signal, performed by a network device. FIG. 11 is a flowchart illustrating a method for sending a wake-up signal provided by an embodiment of the present disclosure. As shown in FIG. 11, the method includes steps 1101-1102.

In step 1101, the network device configures a first low-power wake-up signal and a second low-power wake-up signal.

The implementations of step 1101 are analogous to that of S301, which are not repeated herein.

In step 1102, the network device sends the first low-power wake-up signal to a first user equipment on a first frequency-domain resource and sends the second low-power wake-up signal to a second user equipment on a second frequency-domain resource.

An embodiment of the present disclosure provides a method for sending a wake-up signal, performed by a network device. FIG. 12 is another flowchart for sending a wake-up signal provided by an embodiment of the present disclosure. As shown in FIG. 12, the method includes steps 1201-1203.

In step 1201, the network device configures a first low-power wake-up signal and a second low-power wake-up signal.

The implementations of step 1201 are analogous to that of S401 and will not be repeated herein.

In step 1202, the network device sends first indication information and second indication information to a second user equipment.

The first indication information is configured to indicate configuration information of the first low-power wake-up signal, and the second indication information is configured to indicate configuration information of the second low-power wake-up signal.

Step 1202 may also be that the network device sends the configuration information of the first low-power wake-up signal and the configuration information of the second low-power wake-up signal to the second user equipment.

In step 1203, the network device sends the first low-power wake-up signal to a first user equipment on a first frequency-domain resource and sends the second low-power wake-up signal to the second user equipment on a second frequency-domain resource.

A first bandwidth part and a second bandwidth part may have an overlapping region. In this case, the configuring method and the implementation for sending the wake-up signal may refer to the following embodiments.

An embodiment of the present disclosure provides a configuring method performed by a network device. The method includes: not configuring, by the network device, the second low-power wake-up signal when there is an overlapping region between the first bandwidth part and the second bandwidth part.

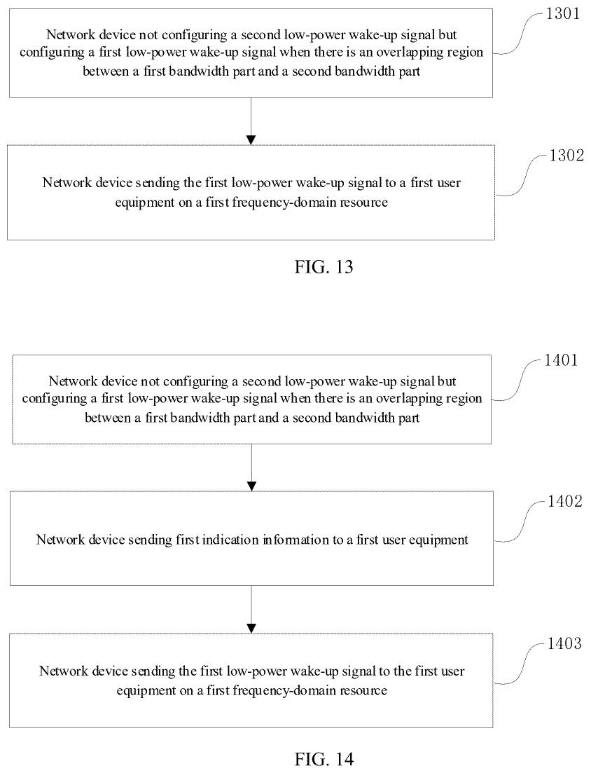

An embodiment of the present disclosure provides a method for sending a wake-up signal, performed by a network device. FIG. 13 is another flowchart for sending a wake-up signal provided by an embodiment of the present disclosure. As shown in FIG. 13, the method includes steps 1301-1303.

In step 1301, the network device does not configure a second low-power wake-up signal and configures a first low-power wake-up signal when there is an overlapping region between a first bandwidth part and a second bandwidth part.

In some possible implementations, configuring the first low-power wake-up signal includes: configuring a first frequency-domain resource based on the first bandwidth part, for example, configuring the first frequency-domain resource within the first bandwidth part.

The details of step 1301 are the same as that of S501 and may refer to S501, which are not repeated herein.

In step 1302, the network device sends the first low-power wake-up signal to the first user equipment on the first frequency-domain resource.

An embodiment of the present disclosure provides a method for sending a wake-up signal, performed by a network device. FIG. 14 is another flowchart for sending a wake-up signal provided by an embodiment of the present disclosure. As shown in FIG. 14, the method includes steps 1401-1403.

In step 1401, when there is an overlapping region between a first bandwidth part and a second bandwidth part, the network device does not configure a second low-power wake-up signal and configures a first low-power wake-up signal.

The details of step 1401 are the same as that of S501 and may refer to S501, which are not repeated herein.

In step 1402, the network device sends first indication information to a first user equipment.

Step 1402 may also be that the network device sends configuration information of the first low-power wake-up signal to the first user equipment.

In step 1403, the network device sends the first low-power wake-up signal to the first user equipment on a first frequency-domain resource.

An embodiment of the present disclosure provides a configuring method performed by a network device. The method includes: not configuring, by the network device, a second low-power wake-up signal when there is an overlapping region between a first bandwidth part and a second bandwidth part.

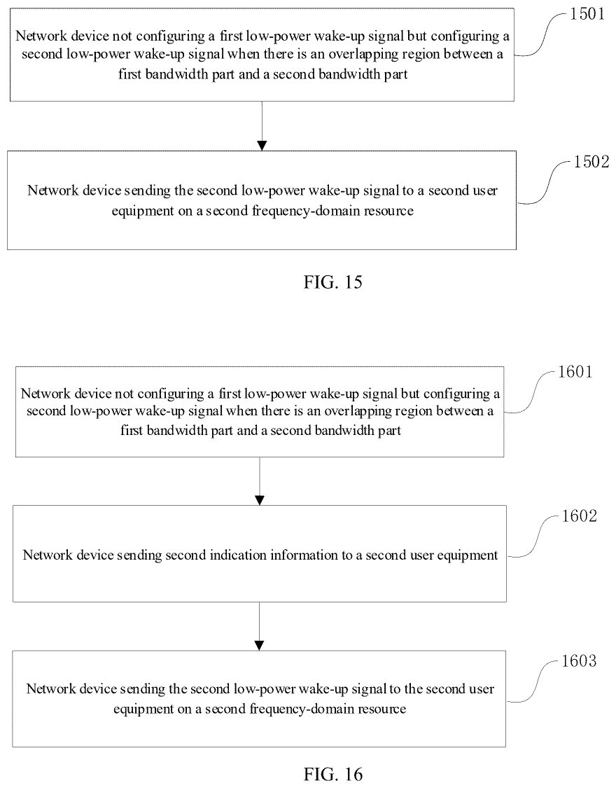

An embodiment of the present disclosure provides a method for sending a wake-up signal performed by a network device. FIG. 15 is another flowchart for sending a wake-up signal provided by an embodiment of the present disclosure. As shown in FIG. 15, the method includes steps 1501-1503.

In step 1501, the network device does not configure a first low-power wake-up signal and configures a second low-power wake-up signal when there is an overlapping region between a first bandwidth part and a second bandwidth part.

The details of step 1501 are the same as that of S701 and may refer to S701, which are not repeated herein.

In step 1502, the network device sends the second low-power wake-up signal to a second user equipment on a second frequency-domain resource.

An embodiment of the present disclosure provides a method for sending a wake-up signal, performed by a network device. FIG. 16 is another flowchart for sending a wake-up signal provided by an embodiment of the present disclosure. As shown in FIG. 16, the method includes steps 1601-1603.

In step 1601, the network device does not configure a first low-power wake-up signal and configures a second low-power wake-up signal when there is an overlapping region between the first bandwidth part and the second bandwidth part.

In some possible implementations, configuring the second low-power wake-up signal includes: configuring a second frequency-domain resource based on the second bandwidth part, for example, configuring the second frequency-domain resource within the second bandwidth part.

The details of step 1601 are the same as that of S701 and may refer to S701, which are not repeated herein.

In step 1602, the network device sends second indication information to a second user equipment.

Step 1602 may also be that the network device sends configuration information of the second low-power wake-up signal to the second user equipment.

In step 1603, the network device sends the second low-power wake-up signal to the second user equipment on the second frequency-domain resource.

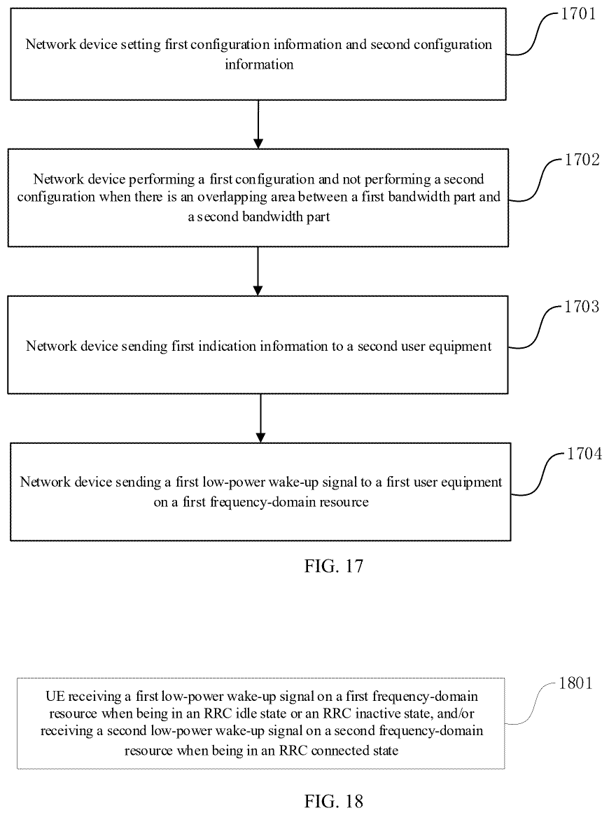

An embodiment of the present disclosure provides a method for sending a wake-up signal, performed by a network device. FIG. 17 is another flowchart for sending a wake-up signal provided by an embodiment of the present disclosure. As shown in FIG. 17, the method includes steps 1701-1703.

In step 1701, the network device sets first configuration information and second configuration information.

The details of step 1701 are the same as that of S901 and may refer to S901, which are not repeated herein.

In step 1702, when there is an overlapping area between a first bandwidth part and a second bandwidth part, the network device performs a first configuration and does not perform a second configuration.

The details of step 1702 are the same as that of S902 and may refer to S902, which are not repeated herein.

In step 1703, the network device sends first indication information to a second user equipment.

Step 1703 may also be that the network device sends configuration information of a first low-power wake-up signal to the second user equipment.

In step 1704, the network device sends the first low-power wake-up signal to a first user equipment on a first frequency-domain resource.

An embodiment of the present disclosure provides a method for receiving a wake-up signal, performed by a user equipment. FIG. 18 is a flowchart for receiving a wake-up signal provided by an embodiment of the present disclosure. As shown in FIG. 18, the method includes step 1801.

In step 1801, the UE receives a first low-power wake-up signal on a first frequency-domain resource when being in an RRC idle state or an RRC inactive state, and/or receives a second low-power wake-up signal on a second frequency-domain resource when being in an RRC connected state.

In an embodiment of the present disclosure, the first frequency-domain resource is a frequency-domain resource occupied by the first low-power wake-up signal, and the second frequency-domain resource is a frequency-domain resource occupied by the second low-power wake-up signal. The first frequency-domain resource and the second frequency-domain resource are different. The first low-power wake-up signal is configured to wake up the first user equipment, which is in a radio resource control (RRC) idle state or RRC inactive state, and the second low-power wake-up signal is configured to wake up the second user equipment, which is in an RRC connected state. That is, the low-power wake-up signal for waking up the UE in the RRC connected state is different from the low-power wake-up signal for waking up the UE not in the RRC connected state.

In some possible implementations, the first low-power wake-up signal and the second low-power wake-up signal are different.

For example, both the first low-power wake-up signal and the second low-power wake-up signal indicate wake-up based on a UE group, however the manners in which the UE groups thereof are divided may be different, and the numbers of UE groups thereof may also be different, therefore, the numbers of bits carried by the first and second low-power wake-up signals is also are different.

For another example, the first low-power wake-up signal indicates wake-up based on a UE group, and the second low-power wake-up signal indicates wake-up not based on a UE group.

In some possible implementations, there may be one or more first user equipments and one or more second user equipments within a single cell. For the same UE, the UE may be in one of an RRC idle state, an RRC inactive state, or an RRC connected state at a same time point, therefore, the UE is the first user equipment or the second user equipment at the same time point. The UE may be in different states at different time points, therefore, the UE may be the same type of user equipment or different types of user equipment at different time points. For example, if the UE is in the RRC idle state at the first time point, the UE is the first user equipment at the first time point. If the UE is in the RRC connected state at the second time point, the UE is the second user equipment at the second time point.

In some possible implementations, there is no overlapping region between the first frequency-domain resource and the second frequency-domain resource.

In some possible implementations, there is an overlapping region between the first bandwidth part and the second bandwidth part, which may include any of the following cases: the first bandwidth part contains the second bandwidth part; the second bandwidth part contains the first bandwidth part; or the first bandwidth part and the second bandwidth part are identical.

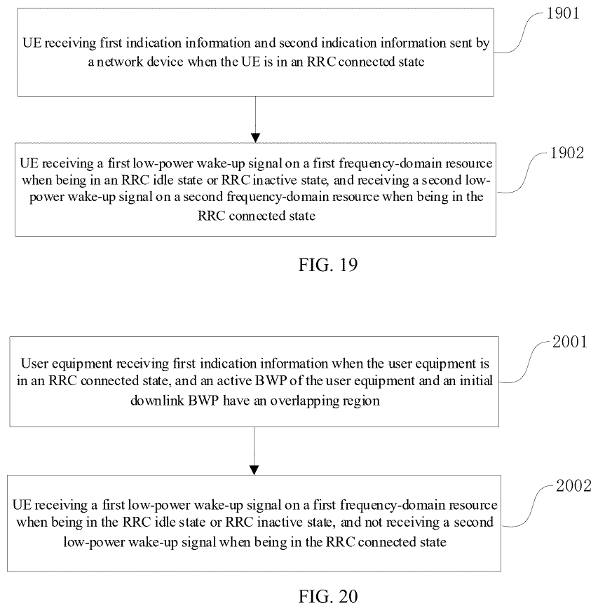

An embodiment of the present disclosure provides a method for receiving a wake-up signal, performed by a user equipment. FIG. 19 is another flowchart for receiving a wake-up signal provided by an embodiment of the present disclosure. As shown in FIG. 19, the method includes steps 1901-1902.

In step 1901, the UE receives first indication information and second indication information sent by a network device when the UE is in an RRC connected state.

The first indication information is configured to indicate configuration information of a first low-power wake-up signal, and the second indication information is configured to indicate configuration information of a second low-power wake-up signal.

Step 1901 may also be that the UE receives the configuration information of the first low-power wake-up signal and the configuration information of the second low-power wake-up signal sent by the network device when the UE is in the RRC connected state.

In step 1902, the UE receives the first low-power wake-up signal on a first frequency-domain resource when being in an RRC idle state or RRC inactive state, and receives the second low-power wake-up signal on a second frequency-domain resource when being in the RRC connected state.

The details of step 1902 are the same as that of step 1801 and may refer to step 1801, which are not repeated herein.

In some possible implementations, there is no overlapping region between the first frequency-domain resource and the second frequency-domain resource.

An embodiment of the present disclosure provides a method for receiving a wake-up signal, performed by a user equipment. FIG. 20 is another flowchart for receiving a wake-up signal provided by an embodiment of the present disclosure. As shown in FIG. 20, the method includes steps 2001-2003.

In step 2001, the user equipment receives first indication information when the user equipment is in an RRC connected state, and an active bandwidth part (BWP) of the user equipment and an initial downlink BWP have an overlapping region.

The first indication information is configured to indicate configuration information of a first low-power wake-up signal.

When the user equipment is in the RRC connected state, the active bandwidth part (BWP) of the user equipment and the initial downlink BWP have an overlapping region, and the use equipment receives the first indication information, the network device is not expected to send second indication information. The second indication information is configured to indicate configuration information of a second low-power wake-up signal.

It is to be understood that if the active BWP of the UE in the RRC connected state and the initial BWP have an overlapping region, and the network device has already configured a wake-up signal for the UE in the RRC idle/inactive state, the UE does not expect the network device to configure a wake-up signal for the UE in the RRC connected state.

Step 2001 may also be that when the UE is in the RRC connected state and the activated BWP of the UE and the initial downlink BWP have an overlapping region, the UE receives the configuration information of the first low-power wake-up signal and does not expect the network device to send the configuration information of the second low-power wake-up signal.

In step 2002, the UE receives the first low-power wake-up signal on a first frequency-domain resource when being in the RRC idle state or RRC inactive state, and does not receive the second low-power wake-up signal when being in the RRC connected state.

The first bandwidth part is configured for the first low-power wake-up signal, and the second bandwidth part is configured for the second low-power wake-up signal.

In an example, the first bandwidth part is all or part of the initial downlink bandwidth part (BWP), and the second bandwidth part is all or part of the active BWP.

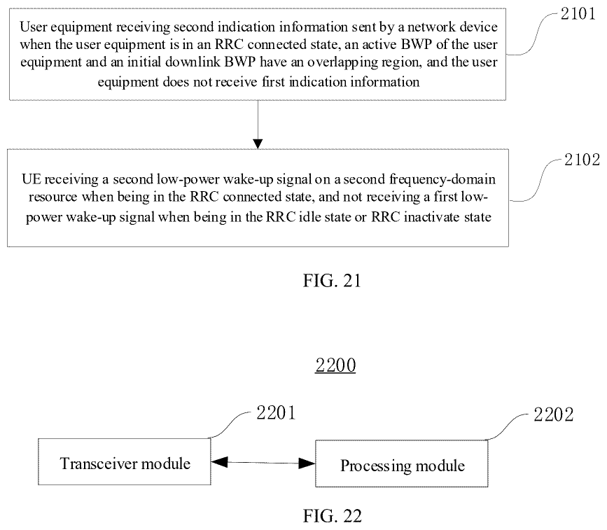

An embodiment of the present disclosure provides a method for receiving a wake-up signal, performed by a user equipment. FIG. 21 is another flowchart for receiving a wake-up signal provided by an embodiment of the present disclosure. As shown in FIG. 21, the method includes steps 2101-2103.

In step 2101, the user equipment receives second indication information sent by a network device when the user equipment is in an RRC connected state, an active bandwidth part (BWP) of the user equipment and an initial downlink BWP have an overlapping region, and the user equipment does not receive first indication information.

The first indication information is configured to indicate configuration information of a first low-power wake-up signal, and the second indication information is configured to indicate configuration information of a second low-power wake-up signal.

It is to be understood that if the active BWP of the UE in the RRC connected state and the initial BWP have an overlapped region, the UE in the RRC connected state may be configured with a wake-up signal for the RRC connected state only when the network device has not configured a wake-up signal for the UE in the RRC idle/inactive state.

Step 2101 may also be that the user equipment receives the configuration information of the second low-power wake-up signal sent by the network device when the user equipment is in the RRC connected state, the active bandwidth part (BWP) of the user equipment and the initial downlink BWP have an overlapping region, and the user equipment does not receive the configuration information of the first low-power wake-up signal.

In step 2102, the UE receives the second low-power wake-up signal on the second frequency-domain resource when being in the RRC connected state, and does not receive the first low-power wake-up signal when being in the RRC idle state or RRC inactivate state.

The first bandwidth part is configured for the first low-power wake-up signal, and the second bandwidth part is configured for the second low-power wake-up signal.

In an example, the first bandwidth part is all or part of the initial downlink bandwidth part (BWP), and the second bandwidth part is all or part of the active BWP.

Based on the same concept as the above method embodiments, an embodiment of the present disclosure also provides an electronic device that may have the function of the network device in the above method embodiments and may be used to perform the steps performed by the network device provided by the above method embodiments. The function may be implemented by hardware, or by software, or by hardware executing corresponding software. The hardware or software includes one or more modules corresponding to the function described above.

In a possible implementation, the electronic device 2200 shown in FIG. 22 may serve as the network device involved in the above method embodiments and perform the steps performed by the network device in one of the above method embodiments.

The electronic device 2200 includes a transceiver module 2201 and a processing module 2202.

The transceiver module 2201 is configured to send a first low-power wake-up signal to a first user equipment on a first frequency-domain resource, and/or send a second low-power wake-up signal to a second user equipment on a second frequency-domain resource.

The first low-power wake-up signal is configured to wake up the first user equipment, the second low-power wake-up signal is configured to wake up the second user equipment, the first user equipment is in a radio resource control (RRC) idle state or an RRC inactive state, the second user equipment is in an RRC connected state, and the first frequency-domain resource is different from the second frequency-domain resource.

In some possible implementations, the first frequency-domain resource and the second frequency-domain resource have no overlapping region.

In some possible implementations, the processing module 2202 is further configured to configure the first low-power wake-up signal and the second low-power wake-up signal.

In some possible embodiments, the processing module 2202 is further configured to not configure the second low-power wake-up signal when a first bandwidth part and a second bandwidth part have an overlapping region, wherein the first bandwidth part is a candidate bandwidth part for configuring the first low-power wake-up signal, and the second bandwidth part is a candidate bandwidth part for configuring the second low-power wake-up signal.

In some possible implementations, the processing module 2202 is further configured to configure the first low-power wake-up signal.

In some possible implementations, the processing module 2202 is further configured to configure the first frequency-domain resource based on the first bandwidth part.

In some possible embodiments, the transceiver module 2201 is also configured to send configuration information of the first low-power wake-up signal to the second user equipment.

In some possible implementations, the processing module 2202 is also configured to not configure the first low-power wake-up signal when a first bandwidth part and a second bandwidth part have an overlapping region, wherein the first bandwidth part is a candidate bandwidth part for configuring the first low-power wake-up signal, and the second bandwidth part is a candidate bandwidth part for configuring the second low-power wake-up signal.

In some possible implementations, the processing module 2202 is also configured to configure the second low-power wake-up signal.

In some possible implementations, the processing module 2202 is also configured to configure the second frequency-domain resource based on the second bandwidth part.

In some possible embodiments, the transceiver module 2201 is further configured to send configuration information of the second low-power wake-up signal to the second user equipment.

In some possible embodiments, the processing module 2202 is further configured to perform a first configuration and not perform a second configuration when a first bandwidth part and the second bandwidth part have an overlapping region, wherein the first configuration is configured to configure the first low-power wake-up signal, the second configuration is configured to configure the second low-power wake-up signal, the first bandwidth part is a candidate bandwidth part for configuring the first low-power wake-up signal, and the second bandwidth part is a candidate bandwidth part for configuring the second low-power wake-up signal.

In some possible implementations, the first bandwidth part is an entire or partial initial downlink bandwidth part (BWP), and the second bandwidth part is an entire or partial active BWP.

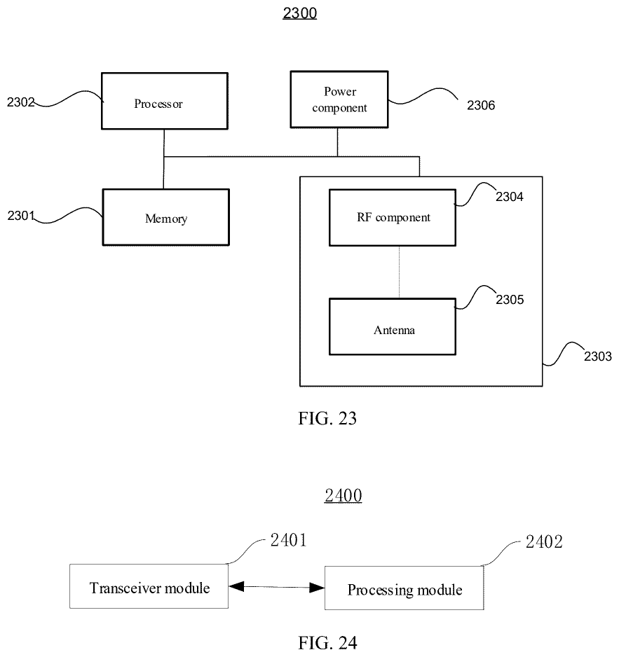

When the electronic device is a network device, the structure thereof may also be shown in FIG. 23. As shown in FIG. 23, the electronic device 2300 includes a memory 2301, a processor 2302, a transceiver component 2303, and a power component 2306. The memory 2301 is coupled to the processor 2302 and may be used to store programs and data necessary for the electronic device 2300 to implement various functions. The processor 2302 is configured to support the electronic device 2300 to perform the corresponding functions in the method described above, and the functions may be realized by calling programs stored in the memory 2301. The transceiver component 2303 may be a wireless transceiver that may be used to support the electronic device 2300 to receive signal and/or data and send signal and/or data via a wireless radio. The transceiver component 2303 may also be referred to as a transceiver unit or a communication unit. The transceiver component 2303 may include a radio frequency (RF) component 2304 and one or more antennas 2305. The RF component 2304 may be a remote radio unit (RRU), which may be specifically used for the transmission of RF signals and the conversion between RF signals and baseband signals. The one or more antennas 2305 may be used specifically for radiation and reception of RF signals.

When the electronic device 2300 needs to send data, the processor 2302 may perform baseband processing on the data to be sent and then output a baseband signal to a RF unit. The RF unit performs RF processing on the baseband signal, and then transmits a RF signal in the form of electromagnetic waves through the antenna. When there is data sent to the electronic device 2300, the RF unit receives the RF signal through the antenna, converts the RF signal into a baseband signal, and outputs the baseband signal to the processor 2302, which converts the baseband signal into data and processes the data.

Based on the same concept as the above method embodiments, an embodiment of the present disclosure also provides an electronic device that may have the function of the user equipment in the above method embodiments and may be used to perform the steps performed by the user equipment provided by the above embodiments. The function may be implemented by hardware, or by software, or by hardware executing corresponding software. The hardware or software includes one or more modules corresponding to the function described above.

In a possible implementation, the electronic device 2400 shown in FIG. 24 may serve as the user equipment involved in the above method embodiments and performs the steps performed by the user equipment in one of the above method embodiments.

The electronic device 2400 includes a transceiver module 2401 and a processing module 2402.

The transceiver module 2401 is further configured to receive a first low-power wake-up signal on a first frequency-domain resource when the user equipment is in a radio resource control (RRC) idle state or an RRC inactive state, and/or receive a second low-power wake-up signal on a second frequency-domain resource when the user equipment is in an RRC connected state.

The first low-power wake-up signal is configured to wake up a first user equipment, the second low-power wake-up signal is configured to wake up a second user equipment, the first user equipment is in the RRC idle state or RRC inactive state, the second user equipment is in the RRC connected state, and the first frequency-domain resource is different from the second frequency-domain resource.

In some possible implementations, the first frequency-domain resource and the second frequency-domain resource have no overlapping region.

In some possible implementations, the transceiver module 2401 is further configured to receive configuration information of the first low-power wake-up signal and configuration information of the second low-power wake-up signal sent by a network device when the user equipment is in the RRC connected state.

In some possible implementations, the transceiver module 2401 is further configured to not expect the network device to send configuration information of the second low-power wake-up signal when the user equipment is in the RRC connected state, an active bandwidth part (BWP) of the user equipment and an initial downlink BWP have an overlapping region, and the user equipment receives configuration information of the first low-power wake-up signal.

In some possible embodiments, the transceiver module 2401 is further configured to receive configuration information of the second low-power wake-up signal sent by the network device when the user equipment is in the RRC connected state, an active bandwidth part (BWP) of the user equipment and an initial downlink BWP have an overlapping region, and the user equipment does not receive configuration information of the first low-power wake-up signal.

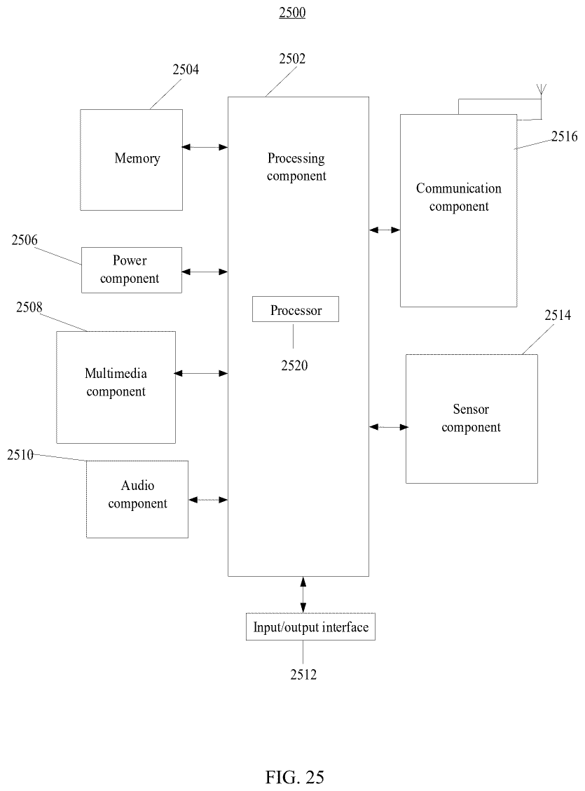

When the electronic device is the user equipment, the structure thereof may also be as shown in FIG. 25. The electronic device 2500 may be a mobile phone, a computer, a digital broadcasting terminal, a message transceiver device, a gaming console, a tablet device, a medical device, a fitness device, a personal digital assistant, and the like.

Referring to FIG. 25, the electronic device 2500 may include one or more of a processing component 2502, a memory 2504, a power component 2506, a multimedia component 2508, an audio component 2510, an input/output (I/O) interface 2512, a sensor component 2514, and a communication component 2516.

The processing component 2502 generally controls the overall operations of the electronic device 2500, such as operations associated with display, telephone calls, data communications, camera operations, and recording operations. The processing component 2502 may include one or more processors 2520 to execute instructions to complete all or part of the steps of the foregoing method. In addition, the processing component 2502 may include one or more modules to facilitate interaction between the processing component 2502 and other components. For example, the processing component 2502 may include a multimedia module to facilitate the interaction between the multimedia component 2508 and the processing component 2502.

The memory 2504 is configured to store various types of data to support the operation at the electronic device 2500. Examples of these data include instructions for any application or method operating on the electronic device 2500, contact data, phone book data, messages, pictures, videos and the like. The memory 2504 may be implemented by any type of volatile or non-volatile storage device or a combination thereof, such as static random access memory (SRAM), electrically erasable programmable read-only memory (EEPROM), erasable and programmable read-only memory (EPROM), programmable read-only memory (PROM), read-only memory (ROM), magnetic memory, flash memory, magnetic disk or optical disk.

The power component 2506 provides power to various components of the electronic device 2500. The power component 2506 may include a power management system, one or more power supplies, and other components associated with generating, managing, and distributing power for the electronic device 2500.

The multimedia component 2508 includes a screen that provides an output interface between the electronic device 2500 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, sliding, and gestures on the touch panel. The touch sensor may not only sense the boundary of the touch or slide action, but also detect the duration and pressure related to the touch or slide operation. In some embodiments, the multimedia component 2508 includes a front camera and/or a rear camera. When the electronic device 2500 is in an operation mode, such as a shooting mode or a video mode, the front camera and/or the rear camera can receive external multimedia data. Each of the front camera and rear camera may be a fixed optical lens system or have focal length and optical zoom capabilities.

The audio component 2510 is configured to output and/or input audio signals. For example, the audio component 2510 includes a microphone (MIC), and when the electronic device 2500 is in an operation mode, such as a call mode, a recording mode, and a voice recognition mode, the microphone is configured to receive an external audio signal. The received audio signal can be further stored in the memory 2504 or sent via the communication component 2516. In some embodiments, the audio component 1100 further includes a speaker for outputting audio signals.

The I/O interface 2512 provides an interface between the processing component 2502 and a peripheral interface module. The above-mentioned peripheral interface module may be a keyboard, a click wheel, a button, and the like. These buttons may include but are not limited to home button, volume button, start button, and lock button.

The sensor component 2514 includes one or more sensors for providing the electronic device 2500 with various aspects of state evaluation. For example, the sensor component 2514 can detect the on/off status of the electronic device 2500 and the relative positioning of components. For example, the component is a display and keypad of the electronic device 2500. The sensor component 2514 can also detect the position change of the electronic device 2500 or a component of the electronic device 2500, the presence or absence of contact between the user and the electronic device 2500, the orientation or acceleration/deceleration of the electronic device 2500, and the temperature change of the electronic device 2500. The sensor component 2514 may include a proximity sensor configured to detect the presence of nearby objects when there is no physical contact. The sensor component 2514 may also include a light sensor, such as a CMOS or CCD image sensor, for use in imaging applications. In some embodiments, the sensor component 2514 may also include an acceleration sensor, a gyroscope sensor, a magnetic sensor, a pressure sensor, or a temperature sensor.

The communication component 2516 is configured to facilitate wired or wireless communication between the electronic device 2500 and other devices. The electronic device 2500 can access a wireless network based on a communication standard, such as WiFi, 4G, or 5G, or a combination thereof. In an embodiment, the communication component 2516 receives a broadcast signal or broadcast related information from an external broadcast management system via a broadcast channel. In an embodiment, the communication component 2516 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an embodiment, the electronic device 2500 may be implemented by one or more of application specific integrated circuit (ASIC), digital signal processor (DSP), digital signal processing device (DSPD), programmable logic devices (PLD), field programmable gate array (FPGA), controller, microcontroller, microprocessor, or other electronic components, to perform the above-mentioned methods.

An embodiment also provides a non-transitory computer-readable storage medium including instructions, such as the memory 2504 including instructions, and the instructions may be executed by the processor 2520 of the electronic device 2500 to complete the foregoing method. For example, the non-transitory computer-readable storage medium may be ROM, random access memory (RAM), CD-ROM, magnetic tape, floppy disk, optical data storage device and the like.

An embodiment of the present disclosure provides a computer-readable storage medium storing instructions that, when being invoked and executed on a computer, cause the computer to perform the above method for sending a wake-up signal or the above method for receiving a wake-up signal.

A person skilled in the art may easily conceive of other implementations of the embodiments of the present disclosure upon consideration of the specification and practice of the invention disclosed herein. The present disclosure is intended to cover any variations, uses, or adaptations of the embodiments of the present disclosure that follow the general principle of the embodiments of the present disclosure and include the common knowledge or conventional technical means in the technical field not disclosed by the present disclosure. The specification and embodiments are to be regarded as exemplary only, with the true scope and spirit of the present disclosure being indicated by the following claims.

It is to be understood that the embodiments of the present disclosure are not limited to the precise structures described above and illustrated in the accompanying drawings, and that various modifications and changes may be made without departing from the scope thereof. The scope of the embodiments of the present disclosure is limited only by the appended claims.

A network device sends a first low-power wake-up signal to a first user equipment on a first frequency-domain resource to wake up a main transceiver of the first user equipment, and sends a second low-power wake-up signal to a second user equipment on a second frequency-domain resource to wake up a main transceiver of the second user equipment. The first user equipment is in an RRC idle state or an RRC inactive state, and the second user equipment is in an RRC connected state. Thus, the network device achieves coexistence of the first low-power wake-up signal and the second low-power wake-up signal by sending different low-power wake-up signals to the user equipments in different states on different frequency-domain resources, thereby avoiding mutual interference between two wake-up signals.

1. A method for sending a wake-up signal performed by a network device, the method comprising at least one of:
sending a first low-power wake-up signal to a first user equipment on a first frequency-domain resource, or sending a second low-power wake-up signal to a second user equipment on a second frequency-domain resource,
wherein the first low-power wake-up signal is configured to wake up the first user equipment, the second low-power wake-up signal is configured to wake up the second user equipment, the first user equipment is in a radio resource control (RRC) idle state or an RRC inactive state, the second user equipment is in an RRC connected state, and the first frequency-domain resource is different from the second frequency-domain resource.

2. The method according to claim 1, wherein the first frequency-domain resource and the second frequency-domain resource have no overlapping region.

3. The method according to claim 1, wherein the method further comprises: configuring the first low-power wake-up signal and the second low-power wake-up signal.

4. The method according to claim 1, wherein the method further comprises:
not configuring the second low-power wake-up signal in response to determining that a first bandwidth part and a second bandwidth part have an overlapping region, wherein the first bandwidth part is a candidate bandwidth part for configuring the first low-power wake-up signal, and the second bandwidth part is a candidate bandwidth part for configuring the second low-power wake-up signal.

5. The method according to claim 4, wherein the method further comprises: configuring the first low-power wake-up signal.

6. The method according to claim 5, wherein configuring the first low-power wake-up signal comprises:
configuring the first frequency-domain resource based on the first bandwidth part.

7. The method according to claim 5, wherein the method further comprises: sending configuration information of the first low-power wake-up signal to the second user equipment.

8. The method according to claim 1, wherein the method further comprises:
not configuring the first low-power wake-up signal in response to determining that a first bandwidth part and a second bandwidth part have an overlapping region, wherein the first bandwidth part is a candidate bandwidth part for configuring the first low-power wake-up signal, and the second bandwidth part is a candidate bandwidth part for configuring the second low-power wake-up signal.

9. The method according to claim 8, wherein the method further comprises: configuring the second low-power wake-up signal.

10. The method according to claim 9, wherein configuring the second low-power wake-up signal comprises:
configuring the second frequency-domain resource based on the second bandwidth part.

11. The method according to claim 9, wherein the method further comprises: sending configuration information of the second low-power wake-up signal to the second user equipment.

12. The method according to claim 1, wherein the method further comprises:
performing a first configuration and not performing a second configuration in response to determining that a first bandwidth part and a second bandwidth part have an overlapping region, wherein the first configuration is configured to configure the first low-power wake-up signal, the second configuration is configured to configure the second low-power wake-up signal, the first bandwidth part is a candidate bandwidth part for configuring the first low-power wake-up signal, and the second bandwidth part is a candidate bandwidth part for configuring the second low-power wake-up signal.

13. The method according to claim 4, wherein the first bandwidth part is an entire or partial initial downlink bandwidth part (BWP), and the second bandwidth part is an entire or partial active BWP.

14. A method for receiving a wake-up signal performed by a user equipment, comprising:
receiving a first low-power wake-up signal on a first frequency-domain resource in response to determining that the user equipment is in a radio resource control (RRC) idle state or an RRC inactive state, or receiving a second low-power wake-up signal on a second frequency-domain resource in response to determining that the user equipment is in an RRC connected state,
wherein the first low-power wake-up signal is configured to wake up a first user equipment, the second low-power wake-up signal is configured to wake up a second user equipment, the first user equipment is in the RRC idle state or RRC inactive state, the second user equipment is in the RRC connected state, and the first frequency-domain resource is different from the second frequency-domain resource.

15. The method according to claim 14, wherein the first frequency-domain resource and the second frequency-domain resource have no overlapping region.

16. The method according to claim 14, wherein the method further comprises:
receiving configuration information of the first low-power wake-up signal and configuration information of the second low-power wake-up signal sent by a network device in response to determining that the user equipment is in the RRC connected state.

17. The method according to claim 14, wherein the method further comprises:
not expecting a network device to send configuration information of the second low-power wake-up signal in response to determining that the user equipment is in the RRC connected state, an active bandwidth part (BWP) of the user equipment and an initial downlink BWP have an overlapping region, and the user equipment receives configuration information of the first low-power wake-up signal.

18. The method according to claim 14, wherein the method further comprises:
receiving configuration information of the second low-power wake-up signal sent by a network device in response to determining that the user equipment is in the RRC connected state, an active bandwidth part (BWP) of the user equipment and an initial downlink BWP have an overlapping region, and the user equipment does not receive configuration information of the first low-power wake-up signal.

19-20. (canceled)

21. An electronic device applied in a network device and comprising:
a memory that stores a computer program; and
one or more processors, wherein
wherein the computer program when collectively executed by the one or more processors cause the electronic device to:
send a first low-power wake-up signal to a first user equipment on a first frequency-domain resource, or sending a second low-power wake-up signal to a second user equipment on a second frequency-domain resource,
wherein the first low-power wake-up signal is configured to wake up the first user equipment, the second low-power wake-up signal is configured to wake up the second user equipment, the first user equipment is in a radio resource control (RRC) idle state or an RRC inactive state, the second user equipment is in an RRC connected state, and the first frequency-domain resource is different from the second frequency-domain resource.

22. An electronic device applied in a user equipment and comprising a processor and a memory, wherein
the memory is configured to store a computer program; and
the processor is configured to execute the computer program to implement the method according to claim 14.

23-24. (canceled)
